(19) United States
(12) Patent Application Publication
(10) Pub. No.: US 2008/0104285 A1
(43) Pub. Date: May 1, 2008

(54) METHOD AND SYSTEM FOR MONITORING DEVICE PORT

(75) Inventors: Wei XIONG, Guangdong (CN); Liansheng XIE, Guangdong (CN); Xiqian XIE, Guangdong (CN)

Correspondence Address: SUGHRUE MION, PLLC, 2100 PENNSYLVANIA AVENUE, N.W., SUITE 800, WASHINGTON, DC, 20037, US

(73) Assignee: HUAWEI TECHNOLOGIES CO., LTD., Guangdong (CN)

(21) Appl. No.: 11/967,833

(22) Filed: Dec. 31, 2007

Related U.S. Application Data
(63) Continuation of application No. PCT/CN2006/001603, filed on Jul. 7, 2006.

(30) Foreign Application Priority Data
Jul. 8, 2005 (CN) 200510035915.7

(51) Int. Cl. G06F 3/00; G06F 15/173; G08B 21/00

(52) U.S. Cl. 710/15; 709/224; 340/679

(57) ABSTRACT

A device port monitoring system is disclosed by embodiments of the present invention, and the system includes an indicator status tracking module coupled with each distributed device respectively. And the indicator status tracking module is used for generating a tracking instruction according to inputted information for tracking a specific port, sending to a specific device a message to initiate an indicator status tracking task, displaying a status of a specific port returned by the specific device. The device port monitoring system and method in accordance with the embodiments of the present invention use a dynamic registration tracking task to reduce the port monitoring overhead, which makes it convenient to monitor a port. In this way, it is possible to guarantee the real-time tracking and effectively reduce the resource overhead in the case that the amount of port is enormous. The embodiments of the present invention also disclose an indicator status tracking module.

### FIELD OF THE INVENTION

The present invention relates to a network management method and system, more particularly, relates to a method and a system for monitoring a telecommunication device port in a network management system, and relates to an indicator status tracking module.

### BACKGROUND OF THE INVENTION

A network management (NM) system is a software system for managing various telecommunication devices, by which the configuration, maintenance, monitoring, service distribution and performance analysis for a telecommunication device may be used visually, conveniently and efficiently. In the device and network maintenance work, it is important for a maintainer of telecommunication operator to know status of each port of the running device in real time. For example, each ordinary telephone user corresponds to one Public Switched Telephone Network (PSTN) port; when the user makes a telephone call, the port status is shown as “busy”; when the user hangs up, the port status is shown as “idle”. The maintainer of telecommunication operator will know whether the operation of telecommunication network is normal rapidly by observing the operation state of various ports. Therefore, the network management system must be able to implement the function of knowing the operation condition of various ports on the network in real time. Because the operation ports (such as PSTN ports, Integrated Services Digital Network ports and x Digital Subscriber Line ports) are physically distributed everywhere, and the amount of the operation ports is enormous, it is a challenging task to set forth a solution for observing the status of each port in real time, visually and optionally.

At present, the operation state of each port, for example fault, idle, busy, activation, deactivation or the like, is generally represented by the color of the relevant indicator on the telecommunication device (or board). However, the above method has the following defects: it is impossible to concentratedly observe multiple ports because the physical locations of devices (or boards) are distributed; the indicator of device (or board) is unable to correspond to each port because the amount thereof is limited; it is impossible to optionally track ports, such as the port status of port in designated frame, and the port status of port in designated telephone number segment; it is impossible to directly obtain, from the designated indicator, the correlative information such as the telephone number, configured service type, L3/EF address, terminal type, terminal ID and port name etc corresponding to a failure port; and multiple tracking tasks are unable to exist simultaneously.

Besides, the status of each port may be indicated by setting an emulation panel on the network management system. However, the defect of the method is similar to that of directly observing the indicator of physical device. The method just can implement a concentrated observation of the indicator with different geographical location, but can not avoid other defects.

A window can be used to concentratedly display a specific type port of a device and the status thereof, for example, all information of PSTN ports is displayed in a table. The defect of the method includes: though the display for displaying the designated condition port may be filtered, it is impossible to start/stop tracking the status of the designated condition port because there is no concept of tracking task; for great capacity port data, messages indicating the port status or the change of the port status reported in real time, such as the Trap message of Simple Network Management Protocol (SNMP), have great flows, which influences the performance greatly. It is impossible to track multiple services in parallel and is impossible to automatically stop tracking the port status and save the resource overhead when the hosts, network management system or network is abnormal.

### SUMMARY OF THE INVENTION

The embodiments of the present invention provide a method and a system for monitoring a device port to solve the problem that the existing port monitoring system is unable to monitor the designated port. And the embodiments of the present invention also provide an indicator status tracking module.

The embodiment of the present invention provides a device port monitoring system. The device port monitoring system includes an indicator status tracking module coupled with each distributed device respectively. And the indicator status tracking module is used for generating a tracking instruction according to inputted information for tracking a specific port, sending to a specific device a message to initiate an indicator status tracking task, displaying a status of a specific port returned by the specific device.

The embodiments of the present invention further provide a device port monitoring method, which includes the following processes of:
acquiring inputted information for tracking a specific port;
generating a tracking instruction according to the inputted information and sending to a specific device a message to initiate an indicator status tracking task; and
displaying a status of the specific port returned by the specific device.

The embodiments of the present invention provide an indicator status tracking module, and the indicator status tracking module includes:
a first unit, for generating a tracking instruction according to inputted information for tracking a specific port;
a second unit, for sending to a specific device a message to initiate an indicator status tracking task;
a third unit, for displaying a status of the specific port returned by the specific device;
a fourth unit, for receiving and displaying a status change of the specific port, and stopping the indicator status tracking task according to an instruction or a network status.

The device port monitoring system and method in accordance with the embodiments of the present invention guarantee the real-time tracking, and effectively control the resource overhead in the case that the amount of port is enormous.

### BRIEF DESCRIPTION OF THE DRAWINGS

FIG. 1 is a schematic diagram illustrating the device port monitoring system in accordance with an embodiment of the present invention;

FIG. 2 is a flowchart illustrating the device port monitoring method in accordance with an embodiment of the present invention;

FIG. 3 is a schematic diagram illustrating the process of initiating an indicator status tracking in accordance with the embodiment of the present invention;

FIG. 4 is a schematic diagram illustrating the process of stopping an indicator status tracking in accordance with the embodiment of the present invention;

FIG. 5 is a schematic diagram illustrating the process of reporting an indicator status change in accordance with the embodiment of the present invention;

FIG. 6 is a schematic diagram illustrating the process of acquiring the associated port information in accordance with the embodiment of the present invention;

FIG. 7 is a schematic diagram illustrating the normal handshake process between the indicator status tracking module and a device in accordance with the embodiment of the present invention;

FIG. 8 is a schematic diagram illustrating the abnormal handshake process between the indicator status tracking module and a device in accordance with the embodiment of the present invention.

### DETAILED DESCRIPTION OF THE INVENTION

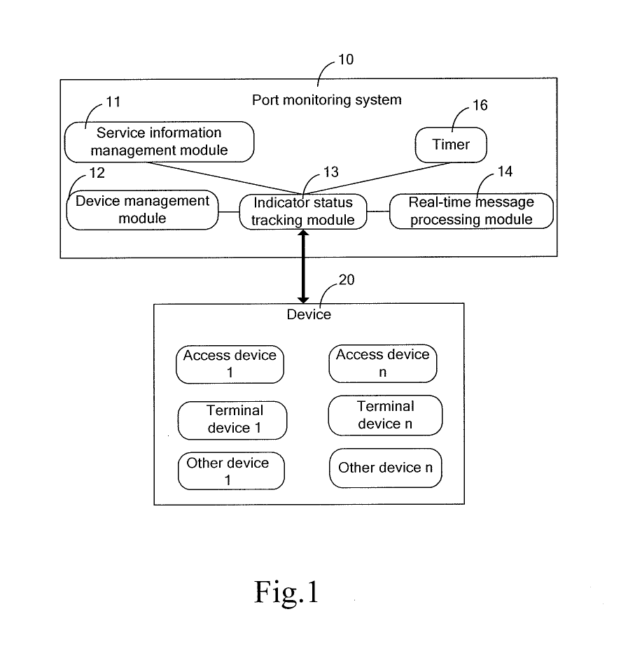

FIG. 1 is a schematic diagram illustrating the device port monitoring system in accordance with an embodiment of the present invention. Port monitoring system 10 includes Indicator status tracking module 13, Service information management module 11, Device management module 12, Real-time message processing module 14 and Timer 16 Indicator status tracking module 13 is connected with Service information management module 11, Device management module 12, Real-time message processing module 14 and Timer 16 respectively. In addition, Indicator status tracking module 13 is communicatively connected with multiple Device 20 (only one Device 20 is shown in FIG. 1) which may be distributed at different places. Each Device 20 may include multiple ports by which Device 20 may be connected with different function devices (for example an access device, a terminal device or other devices) so as to implement the mutual connections of these function devices.

Device management module 12 implemented by retrieving a port database, may generate a list of port according to a tracking condition. Indicator status tracking module 13 includes a Graphic User Interface (GUI) by which Indicator status tracking module 13 may receive the tracking condition (for example, designating to track the port of a specific frame and a specific telephone number segment) or initiate/stop a command for indicator status tracking; the interface may display the indicator status of port by means of the icon form, and the different statuses of indicator may be displayed by different colors in this embodiment. Indicator status tracking module 13 may transfer the received tracking condition to Device management module 12 and generate an instruction according to the list of port returned from Device management module 12, and send a message to a specific device including the corresponding port to initiate or stop the indicator status tracking; the sent information may be determined according to the user requirement, for example the currently-used Simple Network Management Protocol (SNMP) message. Practically, the system and method of the embodiment of the present invention may also be implemented by means of other protocol messages, and is not limited in the embodiment of the present invention. The description is given in the following embodiments of the present invention by taking the SNMP protocol as an example. Device 20 may send to Indicator status tracking module 13 the status of the corresponding port according to the received SNMP message, establish a tracking task list, return the change of port to Indicator status tracking module 13 when the status of the corresponding port is changing. Indicator status tracking module 13 communicates with Device 20 by means of the handshake mode.

Service information management module 11 may retrieve the detailed information associated with the specific port, for example telephone number, configured service type, L3/EF address, terminal type, terminal ID and port name, etc. corresponding to the port; the port properties corresponding to different port types may be different; Service information management module 11 may be implemented by retrieving the corresponding service database. Real-time message processing module 14 may notify Indicator status tracking module 13 of the indicator status change when the indicator status of one port is changing, so that Indicator status tracking module 13 may change the color display of the corresponding port indicator. The reason for directly receiving Trap by Real-time message processing module 14 instead of receiving Trap by Indicator status tracking module 13 is that: there are several types of Trap for one network management system, and the port status change Trap is only one type of the Trap, it is simpler and more effective to use one uniform real-time message processing model to handle the reception or explanation or classification or distribution of these Traps.

Indicator status tracking module 13 includes a counter (not shown in the Figs). The counter initiates a counting when Indicator status tracking module 13 sends an SNMP message to a device, number of the counter adds 1 when the handshake between Indicator status tracking module 13 and Device 20 is failed, and the number of the counter resets when the handshake between Indicator status tracking module 13 and Device 20 is successful. When detecting that the number of the counter achieves a designated value (i.e. the failed handshake exceeds a designated time), Indicator status tracking module 13 stops the corresponding indicator status tracking task and deletes the corresponding tracking task from the tracking task list because the network or the corresponding Device 20 fails at this time. Timer 16 may also be connected with Indicator status tracking module 13 so as to time the timing handshake of multiple tracking tasks thereof.

Service information management module 11, Device management module 12 and Real-time message processing module 14 may be respectively implemented by means of hardware, software or the combination of hardware and software.

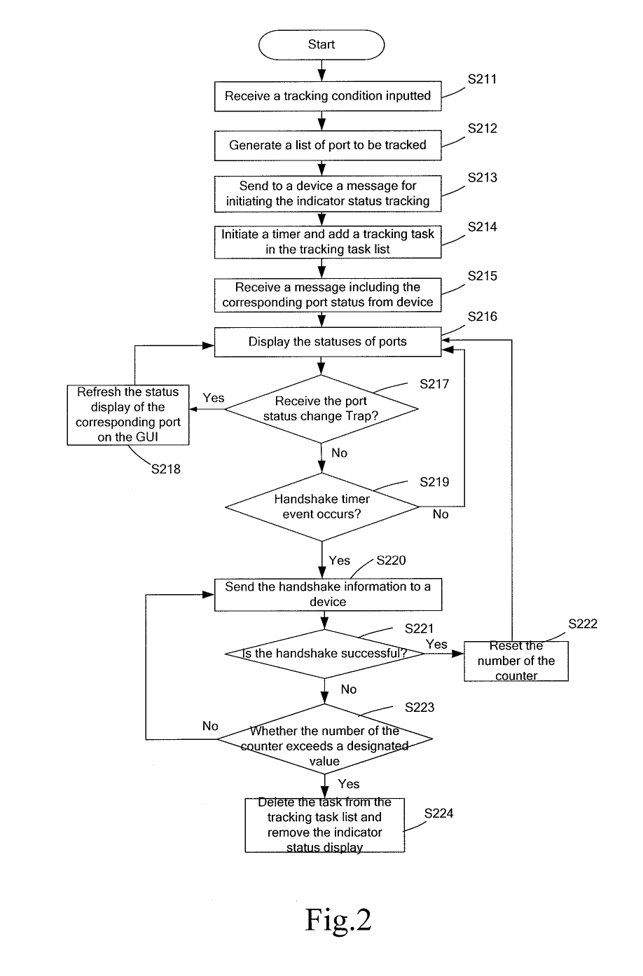

FIG. 2 is a flowchart illustrating the device port monitoring method in accordance with an embodiment of the present invention. At first, Indicator status tracking module 13 receives a tracking condition inputted by a GUI and sends the tracking condition to Device management module 12 (S211); Device management module 12 generates a list of port to be tracked according to the tracking condition and returns the list to Indicator status tracking module 13 (S212). Indicator status tracking module 13 generates an instruction according to the returned list of port so as to send an SNMP message to a specific device including the corresponding port so as to initiate the indicator status tracking (S213). At the same time, Indicator status tracking module 13 initiates a timer and adds the tracking task in the tracking task list by which Indicator status tracking module 13 may simultaneously initiate multiple tracking tasks (S214).

Indicator status tracking module 13 receives a message including the corresponding port status from Device 20 (S215), and displays the statuses of these ports on a GUI by means of the corresponding icons, i.e. the different statuses of ports are indicated by means of the different icon colors (S216), the message may be an SNMP message.

Device 20 may also generate its own tracking task list according to the SNMP message received from Indicator status tracking module 13, and send the indicator status change Trap to Indicator status tracking module 13 when the corresponding port status is changing. When receiving a message from a device, Indicator status tracking module 13 determines whether it is a port status change Trap (S217). If receiving the port status change Trap, Indicator status tracking module 13 refreshes the status display of the corresponding port on the GUI (S218), and returns to S216. At this point, Timer 16 may also periodically detect and determine whether to initiate a handshake program between Indicator status tracking module 13 and Device 20 (S219). The handshake program may be initiated according to a designated condition. For example: the designated condition may include: tracking the port status of the port in designated frame; tracking the port status of the port in designated telephone number segment; only tracking the status of PSTN port, or tracking the port status of the combination of them. If the handshake timer event occurs, Indicator status tracking module 13 sends to Device 20 the handshake information (S220), otherwise returns to S216. If the handshake is successful (S221), i.e. Indicator status tracking module 13 receives the response returned by Device 20, Indicator status tracking module 13 resets the number of the counter (S222), and returns to S216. If receiving no response from the device within the designated time period, Indicator status tracking module 13 makes the number of the counter add 1, and transmits the handshake information again. Indicator status tracking module 13 detects whether the number of the counter exceeds a designated value (S223). If the number of the counter exceeds the designated value, it is indicated that the network may fails; Indicator status tracking module 13 stops the indicator status tracking task, deletes the task from the tracking task list, and removes the indicator status display on the GUI (S224). If the number of the counter does not exceed the designated value, return to S220.

Service information management module 11 may be used to acquire the detailed information associated with a specific port (not shown in FIG. 2), for example telephone number, configured service type, L3/EF address, terminal type, terminal ID and port name etc corresponding to a port.

In addition, Indicator status tracking module 13 may also acquire the corresponding port status by initiatively polling the device port status. The polling time interval may be set according to the requirement; if the polling time interval is long (for example several seconds per time), however, it is impossible to guarantee the real-time; if the polling time interval is short, it is possible to lead to a serious performance problem of the network management system, and devices and the network management system are unable to work normally.

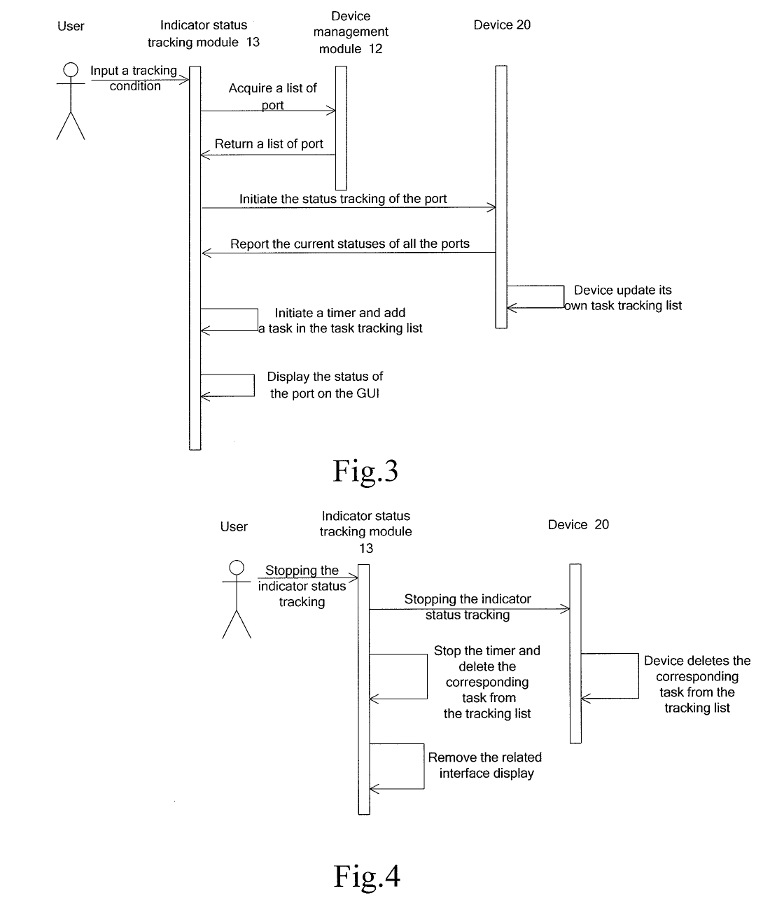

FIG. 3 is a schematic diagram illustrating the process of initiating an indicator status tracking in accordance with the embodiment of the present invention. At first, Indicator status tracking module 13 receives a filtering condition (for example initiating a tracking of port in a frame of a device) for initiating the tracking by means of a Graphic User Interface (GUI), and delivers a command for initiating the indicator status tracking. Indicator status tracking module 13 acquires a list of port which meets a designated condition from Device management module 12. Indicator status tracking module 13 sends to Device 20 an SNMP message to initiate the status tracking of the port meeting the designated condition. Device 20 establishes its own tracking task list, and reports the current statuses of all the ports meeting the designated condition by means of Trap. At the same time, Indicator status tracking module 13 initiates a handshake timer, and adds a tracking task in the tracking task list. Indicator status tracking module 13 displays the list of tracked port on a GUI, and displays the current status of the corresponding port by means of the different color icons.

FIG. 4 is a schematic diagram illustrating the process of stopping an indicator status tracking in accordance with the embodiment of the present invention. At first, Indicator status tracking module 13 receives a command for stopping the indicator status tracking by means of GUI. Indicator status tracking module 13 sends to Device 20 a command for stopping the indicator status tracking. Device 20 stops the tracking for the corresponding port status, and can not send Trap to the network management system even though the port status is changing. Indicator status tracking module 13 stops the handshake timer, and deletes the corresponding item of the tracking task list. Indicator status tracking module 13 removes the related interface display.

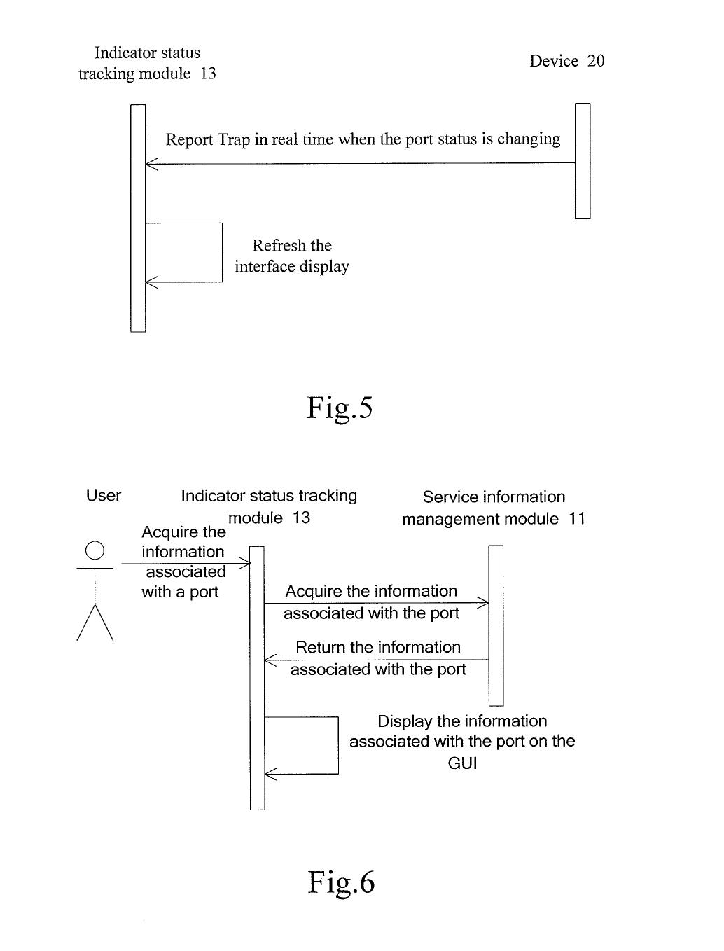

FIG. 5 is a schematic diagram illustrating the process of reporting an indicator status change in accordance with the embodiment of the present invention. When it is detected that the status of the tracked port is changing, Device 20 sends the status change to Indicator status tracking module 13. Real-time message processing module 14 notifies Indicator status tracking module 13 of the fact that the status of a port is changing. Indicator status tracking module 13 refreshes the interface display, and represents the current status of the corresponding port by means of the designated color icon.

FIG. 6 is a schematic diagram illustrating the process of acquiring the associated port information in accordance with the embodiment of the present invention. It is possible to click a port indicator icon on the GUI of Indicator status tracking module 13 to indicate the acquiring the detailed information associated with the port. Indicator status tracking module 13 sends Service information management module 11 a command for acquiring the detailed information of the designated port. Service information management module 11 returns the detailed information of the corresponding port to Indicator status tracking module 13. Indicator status tracking module 13 displays the detailed port information on the GUI.

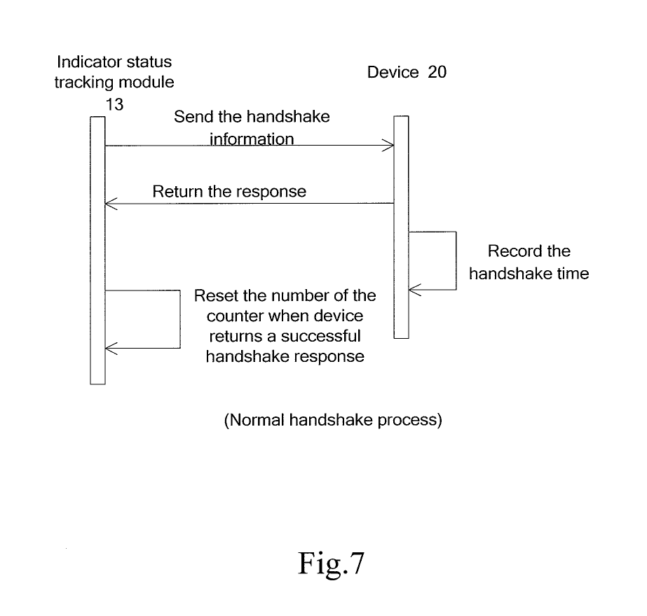

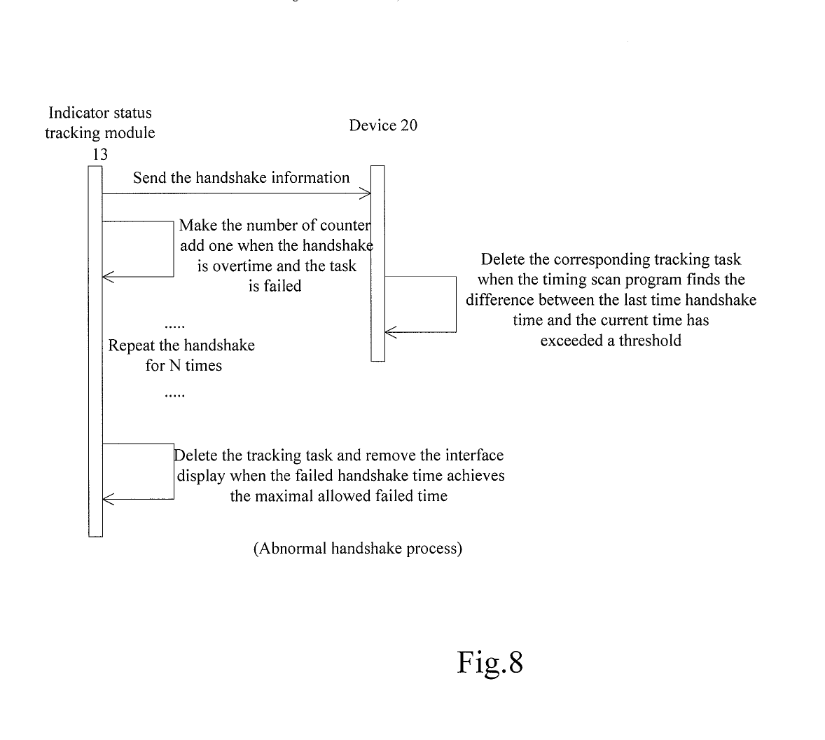

FIG. 7 and FIG. 8 are schematic diagrams illustrating the handshake process between the indicator status tracking module and a device in accordance with the embodiment of the present invention. When the timer periodicity event set in Indicator status tracking module 13 occurs, Indicator status tracking module 13 sends to Device 20 an SNMP message to initiate a handshake program. If Device 20 returns a successful handshake response, Indicator status tracking module 13 resets the number of the counter; if Device 20 gives no response within the designated overtime period, Indicator status tracking module 13 makes the number of the counter add one. If the failed handshake times exceed a designated times, it is determined that the tracking task abnormally is interrupted (for example the network fails); Indicator status tracking module 13 stops the handshake timer, deletes the corresponding item of the tracking task list and removes the corresponding interface display. For an initiated tracking task, if receiving no handshake information sent by Indicator status tracking module 13 within a designated time period (>=the handshake overtime period at the network management side multiplied by the maximal allowed failure times), Device 20 determines that the tracking command is invalid, then stops the indicator status tracking task, and does not send status change Trap of the corresponding port to Indicator status tracking module 13 any more.

1. A device port monitoring system, comprising:
an indicator status tracking module coupled with each distributed device respectively, for generating a tracking instruction according to inputted information for tracking a specific port, sending to a specific device a message to initiate an indicator status tracking task, displaying a status of a specific port returned by the specific device.

2. The system of claim 1, wherein the status of the specific port returned by the specific device comprises a status change of the specific port.

3. The system of claim 1, wherein the indicator status tracking module is further configured to stop the indicator status tracking task according to an instruction or a network status.

4. The system of claim 1, further comprising:
a real-time message processing module, for converting a status change of port into information that can be identified by the indicator status tracking module, and transferring the information to the indicator status tracking module for displaying in real time.

5. The system of claim 1, further comprising:
a service information management module, for obtaining associated information of a corresponding port according to the status received by the indicator status tracking module, and transmitting the information to the indicator status tracking module for displaying the associated information of the corresponding port.

6. The system of claim 1, further comprising:
a device management module, for generating a list of port to be tracked according to a tracking condition transmitted by the indicator status tracking module, and for returning the list of port to the indicator status tracking module;
wherein the indicator status tracking module sends to the specific device a message to initiate the indicator status tracking task according to the list of port.

7. The system of claim 1, further comprising:
a timer, for timing a handshake of the indicator status tracking task initiated by the indicator status tracking module.

8. The system of claim 7, wherein the indicator status tracking module comprises:
a counter, being initiated when the indicator status tracking module sends a handshake message to a device, increasing or decreasing number of the counter when the handshake between the indicator status tracking module and the device is failed, and resetting when the handshake between the indicator status tracking module and the device is successful; and
the indicator status tracking module stops the indicator status tracking task when counting of the counter achieves a designated value.

9. A device port monitoring method, comprising:
acquiring inputted information for tracking a specific port;
generating a tracking instruction according to the inputted information and sending to a specific device a message to initiate an indicator status tracking task; and
displaying a status of the specific port returned by the specific device.

10. The method of claim 9, wherein the status of specific port is a status change of the specific port returned by the specific device.

11. The method of claim 9, further comprising:
stopping the indicator status tracking task according to an instruction or network status.

12. The method of claim 9, wherein the acquiring inputted information for tracking the specific port comprises:
receiving, by an indicator status tracking module, a tracking condition over a Graphic User Interface (GUI), and transferring the tracking condition to a device management module;
generating, by the device management module, a corresponding list of port according to the tracking condition, and returning the list to the indicator status tracking module.

13. The method of claim 9, wherein the generating the tracking instruction according to the inputted information and sending to the specific device the message to initiate the indicator status tracking task comprises:
adding, by an indicator status tracking module, a tracking task in a tracking task list;
executing, by the indicator status tracking module, the tracking task of the tracking task list, generating an instruction and sending to the specific device a message to initiate the tracking task.

14. The method of claim 13, further comprising: initiating, by the indicator status tracking module, a timer, and initiating a handshake program according to the timer.

15. The method of claim 14, wherein the process for handshake program comprises:
initiating a counter for counting, when the indicator status tracking module sends a handshake message to a device;
increasing or decreasing number of the counter, when the handshake between the indicator status tracking module and the device is failed;
resetting number of the counter, when the handshake between the indicator status tracking module and the device is successful; and
stopping, by the indicator status tracking module, the indicator status tracking task when detecting that counting of the counter achieves a designated value.

16. An indicator status tracking module, comprising:
a first unit, for generating a tracking instruction according to inputted information for tracking a specific port;
a second unit, for sending to a specific device a message to initiate an indicator status tracking task;
a third unit, for displaying a status of the specific port returned by the specific device;
a fourth unit, for receiving and displaying a status change of the specific port, and stopping the indicator status tracking task according to an instruction or a network status.

17. The indicator status tracking module of claim 16, further comprising:
a counter, which is initiated when the second unit sends a handshake message to a device, increases or decreases number of the counter when a handshake between the indicator status tracking module and the device is failed, and reset number of the counter when the handshake between the indicator status tracking module and the device is successful;
wherein the fourth unit stops the indicator status tracking task when the number of the counter achieves a designated value.
